(19) United States
(12) Patent Application Publication
(10) Pub. No.: US 2009/0077494 A1
(43) Pub. Date: Mar. 19, 2009

(54) CONTEXTUAL PREDICTION

(75) Inventor: Fredrik Sjolin, Ronneby (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: UIQ TECHNOLOGY AB, Ronneby (SE)

(21) Appl. No.: 12/298,926

(22) PCT Filed: Jun. 26, 2007
(86) PCT No.: PCT/EP07/56368

§ 371 Date: Oct. 29, 2008

(30) Foreign Application Priority Data
Jun. 26, 2006 (GB) 0612627.0

(51) Int. Cl. G06F 3/048

(52) U.S. Cl. 715/810; 715/764

(57) ABSTRACT

The present invention relates to a computing device and method for handling information, comprising: a processing unit (31) running a graphical user interface, i.e. GUI; a memory (32); a graphics handling program for receiving and handling events related to the user interface; a display unit (401); predictive text input system. The processing unit is configured to receive signals indicative of data input from the user interface in an input field having an input field identity and generate a feedback to the user interface based on the data input and the input field identity.

### TECHNICAL FIELD

The present invention relates to a solution for facilitating information entry in computing devices.

### BACKGROUND OF THE INVENTION

For many years, portable computers have been getting smaller and smaller. Tremendous growth in the wireless industry has produced reliable convenient and nearly commonplace mobile devices such as cell phones, personal digital assistants (PDAs), global positioning system (GPS) units, etc.

We are becoming more and more dependent on computing devices in our lives and these devices provide a complex environment to operate in. Graphical user interfaces have been developed in order to facilitate navigation and interaction with the computing devices. To further facilitate the interaction special aids have been developed to allow the user to more easily enter information and/or navigate in complex or information rich environments.

To input data on a portable computer without a standard keyboard has been a goal for many manufacturers of systems and devices. There are a number of approaches to simplify the entering operation. One such approach has been to use keyboards with fewer keys. Some reduced keyboards have used a 3-by-4 array of keys, like the layout of a touch-tone telephone.

Another approach is that some devices have a digitizing surface to receive users' handwriting or selection of signs from a digitalized keypad. This approach permits users to write naturally, for example in a small area as permitted by the size of the portable computer. In case of touch-sensitive panels on which some type of keyboard overlay has been printed, or a touch-sensitive screen with a keyboard overlay displayed. The user employs a finger or a stylus to interact with the panel or display screen in the area associated with the desired key or letter.

Despite the absence of normal user interfaces like a full-size keyboard and mouse, then, the foregoing technologies make it quite feasible for users to fully interact with a portable computer of reduced size. Although feasible, this user-machine interaction is unavoidably burdened with greater potential delay, error, and difficulty of use, owing to the small sized user interface. Consequently, designers are continually searching for new technologies to make the interface more rapid, accurate, and natural.

When for example entering information, textual or numerical, the handheld device is configured to simplify the entry procedure by predictive text feedback, i.e. the unit suggests similar text or number combinations based on the letters/figures entered to the input field(s).

However, the present techniques use general feedback (suggestion) without any consideration on the information type, i.e. the text combinations suggested to the user include all text starting with the entered letters.

### SUMMARY OF THE INVENTION

It is an object of the present invention to provide a solution for further facilitating interfacing in this field of technology. The solution of the present invention will enable predictive systems to better facilitate text input, make it faster and more appealing to use.

Thus, the invention relates to a computing device for handling information, comprising: a processing unit running a graphical user interface, i.e. GUI; a memory; a graphics handling program for receiving and handling events related to the user interface; a display unit; and predictive text input system. The processing unit is configured to receive signals indicative of data input from the user interface in an input field having an input field identity and generate a feedback to the user interface based on the data input and the input field identity. The device may further comprise a mechanism for adding category tags to database entries and associating said category tags with specific input fields on entry fields. The database entries may include at least one of a dictionary, lexical list, name list, address list, calendar list (weekday, month), country list, scientific formulae list. Preferably, the input fields from different applications with similar semantics are grouped together as context groups under a common category tag. According to one embodiment, the predictive text input system is informed of a context category or the system is arranged to query a running application for the context category. The device may further be adapted to determine probable current language from device language or home country and arranged to generate a feedback based on probable current language. The device further comprises a communication interface for wireless communication with an infrastructure gateway, e.g. a mobile phone base station, a WiFi access point, or a Wimax gateway.

The invention also relates to a method for facilitating user data input to a computing device. The method comprising the steps of: receiving entered data directly or indirectly from a user interface; based on data entry receiving information on data input field identity; selecting one or several stored data objects based on said entered data and said data input field identity; and presenting said selected data objects for a user selection.

The invention also relates to a computer program product for facilitating user data input to a computing device, comprising: an instruction set allowing entry of data by a user, an instruction set which based on data entry acquires information on data input field identity; an instruction set for selecting one or several stored data objects based on said entered data and said data input field identity; and an instruction set for presenting said selected data objects for a user selection.

### BRIEF DESCRIPTION OF THE DRAWINGS

In the following the invention will be described in a non-limiting way and in more detail with reference to exemplary embodiments illustrated in the enclosed drawings, in which:

FIGS. 1a and 1b illustrate schematically a display of a device according to the present invention;

FIG. 2 illustrates schematically a flow diagram according of the present invention;

FIG. 3 illustrates schematically an example embodiment of the present invention; and

FIG. 4 illustrates schematically a device according to the present invention;

### DETAILED DESCRIPTION

Basically, the present invention adapts predictive text systems on computing devices to the context in which they operate. In particular, when entering text into fields on the screen of a computing device, use of this invention ensures that only words appropriate to the field being input are suggested as predictive texts.

For example, if a user is using a contacts database or an address book and wants to create a new contact or name and address record, the current prior art would offer all words beginning with “Ro” if those were the first two letters that were typed anywhere on the input screen.

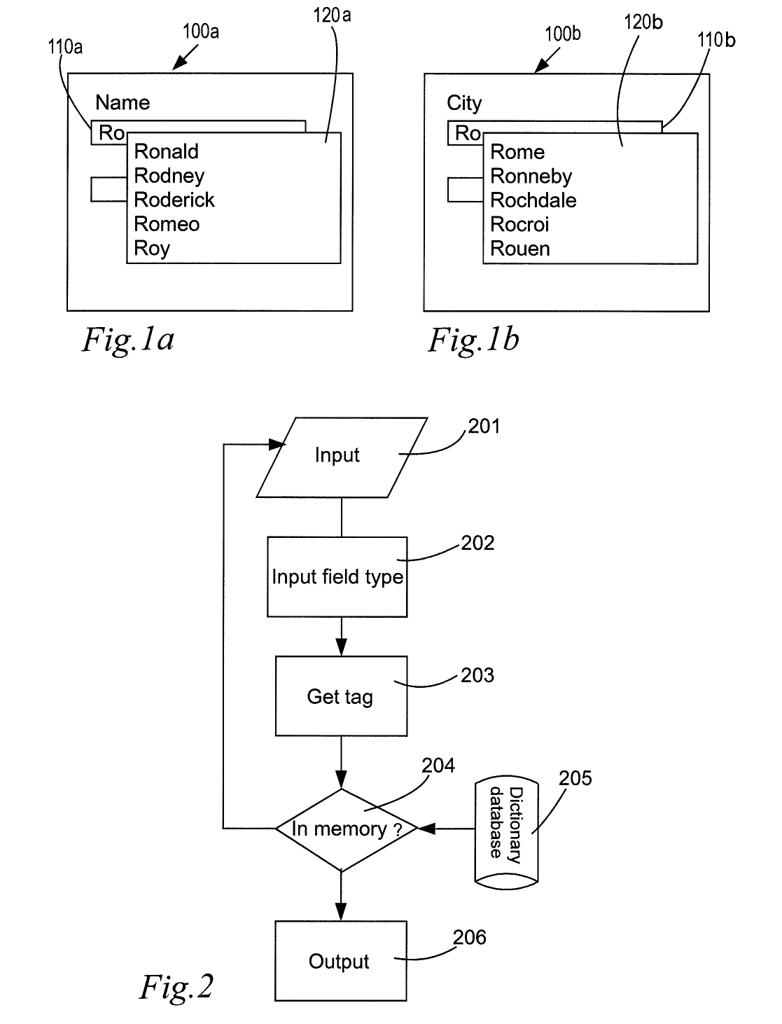

However, by the use of this invention, if ‘Ro’ were entered at the start of the first name field, the predictive text scheme would offer names such as “Ranald”, “Rodney”, “Roderick”, “Romeo” and “Roy”. Were the same characters to be entered in the city field, the predictive text system would instead suggest names such as “Rome”, “Ronneby”, “Rochdale”, “Rocroi”, and “Rouen”. This is illustrated in FIGS. 1a and 1b. In FIG. 1a a screen 100a image of computing device is illustrated comprising an input field 110a labeled “Name”. Upon entry of letters R and o, a rollup menu 120a is shown including the names starting with Ro. Of course the names suggested are limited by entering more letters. The user may choose one of the suggested candidates. In FIG. 1b a screen 100b image of computing device is illustrated comprising an input field 110b labeled “City”. Upon entry of letters R and o, a rollup menu 120b is shown including the names starting with Ro. The user may choose one of the suggested city names at any time or enter full name if a candidate is not suggested.

In order for this to be done, a mechanism for adding category tags to dictionary entries and associating those category tags with specific fields on commonly used entry screen could be added to existing predictive text input systems.

Fields from different applications and different screens with similar semantics could be grouped together as context groups under a common category tag; the predictive text input system could either be informed of the context, or could be enabled to query the running application for the context.

The entries may be one of a dictionary, lexical list, name list, address list, calendar list (weekday, month), country list, scientific formulae list, etc.

FIG. 2 illustrates one exemplary step flow diagram according to the invention. In first step 201, the input from the user is analyzed 202 and if it is, for example a letter and input field is a letter input field, the system acquires 203 the tag for the input field. If, for example, the input field is tagged “name”, or “city”, “address”, etc., the system looks it up 204 in a memory (database) 205 for similar words, e.g. stored in a block under the same tag. The system outputs 206 the results for the user.

Furthermore, a text input system could increase its accuracy by checking to see which language or home country was in use, and ranking or offering suggestions appropriate to the culture or geography in use; so in the example of the city field referred to above, the suggestion of “Ronneby” would appear high on the list for a place name when a user was in Sweden while “Rouen” and “Rocroi” would appear prominently if a user is in France.

The use of this invention could easily be extended to other common fields used on computing devices, such as job title and company.

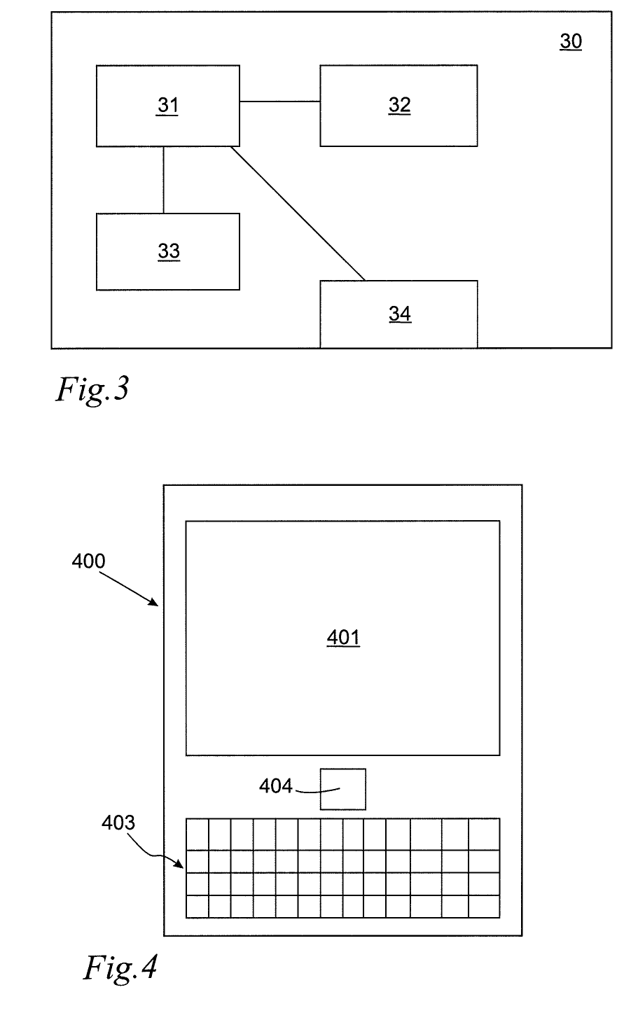

In FIG. 3, reference numeral 30 generally indicate a computing device according to the present invention, where the device may be a desktop or laptop computers, personal digital assistant (PDA), mobile phone, smart phone, digital camera, or digital music player (e.g. MP3 players), or combinations of these. The device 30 comprises a processing unit 31, a volatile and/or non-volatile memory 32, a user interface unit 33, and optionally one or several communication interfaces 34.

The processing unit may for instance be a microprocessor, a computer processor, a DSP (Digital Signal Processor), an FPGA (Field Programmable Gate Array), an ASIC (Application Specific Integrated Circuit), or any other suitable processing unit capable of handling software instructions and/or computational processing.

The memory 32 may comprise any suitable memory known to the skilled person, such as for instance RAM, Hard disk, Flash memory, Secure Digital (SD) of different versions, memory stick of different versions or variations, and EEPROM.

The user interface 33 is arranged to control display of information in a GUI (Graphical User Interface) display. The information may be provided by the processing unit 31. The user interface unit may be built into the processing unit.

The user interface unit is connected to user interfaces such as a display unit (not shown), a keyboard or similar control unit(s), and optionally other user interface equipment depending on type of device and application area (e.g. a mobile phone will have a microphone and loudspeaker connected).

Optionally, a communication interface 34 may be provided. This communication interface may for instance be using a packet based interface protocol over any suitable physical communication channel. The physical communication channel may be wired or wireless depending on type of device. For instance using a desktop or laptop computer, the interface is often wired through for instance an Ethernet connection or it may be wireless using Ethernet over some wireless protocol (e.g. WiFi, Wimax, Wibro, or some other protocol based on any wireless area network protocol (e.g. PAN, PAN, LAN (WLAN), or RAN): IEEE 802.11, 802.15, 802.16, 802.20, 802.22 series of protocols); whereas in a mobile phone the physical channel may be for instance EVDO, CDMA, EDGE, GPRS, HSDPA, or UMTS for instance. The communication channel may also be of a circuit switched character (e.g. GSM) or a combination of these.

As one example, on may mention the use in a mobile phone with a user interface. FIG. 4 shows an example of a mobile phone 400 with a display unit 401 (e.g. controlled by the interface unit 33 of FIG. 3), a keypad 403 with a plurality of interface buttons, and preferably one or several control buttons (e.g. Ok, erase, menu, etc) 404. The phone may also be provided with a camera. The phone is also provided with a microphone and loudspeaker; however, these are not shown. Furthermore, the phone may also be provided with other types of physical interfaces (not shown), e.g. for hands free (wired or wireless) communication link, battery charger connection, removable memory media, and so on.

The term “computing device” includes, without being limited to, Desktop and Laptop computers, Personal Digital Assistants (PDAs), Mobile Telephones, Smartphones, Digital Cameras and Digital Music Players. It also includes converged devices incorporating the functionality of one or more of the classes of device already mentioned, together with many other industrial and domestic electronic appliances.

It should be noted that the word “comprising” does not exclude the presence of other elements or steps than those listed and the words “a” or “an” preceding an element do not exclude the presence of a plurality of such elements. The invention can at least in part be implemented in either software or hardware. It should further be noted that any reference signs do not limit the scope of the claims, and that several “means”, “devices”, and “units” may be represented by the same item of hardware.

The invention may be realized in hardware or software.

The above mentioned and described embodiments are only given as examples and should not be limiting to the present invention. Other solutions, uses, objectives, and functions within the scope of the invention as claimed in the below described patent claims should be apparent for the person skilled in the art.

### DEFINITIONS AND ABBREVIATIONS

CDMA Code division multiple access
EDGE Enhanced Data rates for GSM Evolution
EVDO Evolution-Data Optimized
GPRS General Packet Radio Service
GUI Graphical User Interface
HSDPA High-Speed Downlink Packet Access
IEEE Institute of Electrical and Electronics Engineers
LAN Local Area Network
PAN Personal Area Network
RAN Regional Area Network
UMTS Universal Mobile Telecommunications System
WAN Wide Area Network
WLAN Wireless Local Area Network

1. A computing device for handling information, comprising
a processing unit running a graphical user interface, i.e. GUI;
a memory; —a graphics handling program for receiving and handling events related to the user interface;
a display unit; predictive text input system, wherein the processing unit is configured to receive signals indicative of data input from the user interface in an input field having an input field identity and generate a feedback to the user interface based on the data input and the input field identity,
a mechanism for adding category tags to database entries and associating said category tags with specific input fields on entry fields, and
said device further being adapted to determine current language from device language or home country.

2. The device according to claim 1, wherein database entries include at least one of a dictionary, lexical list, name list, address list, calendar list (weekday, month), country list, scientific formulae list.

3. The device of claim 1, wherein input fields from different applications with similar semantics are grouped together as context groups under a common category tag.

4. The device of claim 1, wherein the predictive text input system is informed of a context category.

5. The device of claim 1, wherein the predictive text input system is arranged to query a running application for the context category.

6. The device according to claim 5, wherein the device is further arranged to generate a feedback based on probable current language.

7. The device according to claim 1, further comprising a communication interface for wireless communication with an infrastructure gateway, e.g. a mobile phone base station, a WIFI access point, or a Wimax gateway.

8. A method for facilitating user data input to a computing device, the method comprising the steps of: receiving entered data directly or indirectly from a user interface; based on data entry receiving information on data input field identity;
adding category tags to database entries and associating said category tags with specific input fields on entry fields,
determining current language from a device language or home country,
selecting one or several stored data objects based on said entered data and said data input field identity; and
presenting said selected data objects for a user selection.

9. A computer program product for facilitating user data input to a computing device, comprising:
an instruction set allowing entry of data by a user,
an instruction set for adding category tags to database entries and associating said category tags with specific input fields on entry fields,
an instruction set for determining current language from a device language or home country,
an instruction set which based on data entry acquires information on data input field identity; an instruction set for selecting one or several stored data objects based on said entered data and said data input field identity; and
an instruction set for presenting said selected data objects for a user selection.
